(19) United States
(12) Patent Application Publication
(10) Pub. No.: US 2025/0196577 A1
(43) Pub. Date: Jun. 19, 2025

(54) Air-Conditioning System for a Vehicle

(71) Applicant: Hanon Systems, Daejeon (KR)

(72) Inventors: Carsten Ohrem, Bergheim (DE); Florian Bieregger, München (DE); Toni Spies, Köln (DE)

(21) Appl. No.: 18/845,791

(22) PCT Filed: Feb. 8, 2023
(86) PCT No.: PCT/KR2023/001856

§ 371 Date: Sep. 10, 2024

(30) Foreign Application Priority Data
Mar. 10, 2022 (DE) 10 2022 105 607.4
Mar. 15, 2022 (DE) 10 2022 105 946.4
Dec. 22, 2022 (DE) 10 2022 134 491.6

(51) Int. Cl. B60H 1/00

(52) U.S. Cl. CPC B60H 1/00885

(57) ABSTRACT

An air-conditioning system for a vehicle, is based on the object of indicating a solution with which a secure functioning, an improvement of the tightness, a reduction of the installation effort and of the costs during production of an air-conditioning system are achieved. This object is achieved by arranging a multi-valve block in the air-conditioning system in which structural parts such as several valves and at least one sensor are arranged, in that the multi-valve block has several attachment points and in that second internal connection lines are arranged between the attachment points and the structural parts of the multi-valve block.

### CROSS REFERENCE TO RELATED PATENT APPLICATIONS

This is a U.S. national phase patent application of PCT/KR2023/001856 filed Feb. 8, 2023 which claims the benefit of and priority to German Patent Application No. DE 10 2022 134 491.6 filed on Dec. 22, 2022, German Patent Application No. DE 10 2022 105 946.4 filed on Mar. 15, 2022, and German Patent Application No. DE 10 2022 105 607.4 filed on Mar. 10, 2022, the entire contents of each of which are incorporated herein by reference for all purposes.

### TECHNICAL FIELD

The invention relates to an air-conditioning system for a vehicle which comprises components such as valves, a refrigerant compressor, sensors and heat exchangers, wherein first external connection lines are arranged between these structural parts at least in regions.

### BACKGROUND ART

It is known from the state of the art that air-conditioning systems as refrigerant circuits with in particular electrical refrigerant compressors, which are driven by means of an electric engine, are employed for air-conditioning of vehicles. This in particular also applies to electrically or at least partially electrically driven vehicles such as electric cars or vehicles with a hybrid drive.

In particular, the description relates to refrigerant circuits of air-conditioning systems where assemblies such as valves, electrical refrigerant compressors, pumps, sensors, heat exchangers and other components which are required in order for the circuits to function are arranged in the system.

An air-conditioning system, which is, for example, employed in a motor vehicle, is also referred to as a motor vehicle air-conditioning system, heat pump system or cooling and heat pump system. Such air-conditioning systems in a vehicle consist of many different components such as a refrigerant compressor, several heat exchangers, such as a condenser, an evaporator, a chiller, different valves, a dryer and sensors for control actions and other parts. Such components must be fixed to the vehicle and mostly require attachments for an operating and/or control voltage in the form of electrical wiring.

According to the known state of the art, the components of the refrigerant circuit are mostly arranged decentralized on different installation locations in a vehicle and connected to one another via so-called connection lines via so-called connection points, also referred to as coupling pieces or fittings.

A disadvantage of this decentralized arrangement is that corresponding costs for the connection lines and the connection points result from the decentralized placement of the components and the required connection lines between these components. This is complemented by the materials and cables required for the fixation of the components and for electrical wiring.

A further disadvantage is that, depending of the line length and deflection or change of direction of the lines, pressure losses in the refrigerant flowing around result which lead to a decrease of the efficiency of the air-conditioning system.

Furthermore, this results in a large number of connection points which at the same time represent sealing points of the refrigerant in the refrigerant circuit to the environment. However, in practice, every single connection point or sealing point has a certain degree of leakage which sums up to a total leakage of the air-conditioning system. Thus, it would be advantageous if the number of these connection points could be kept as low as possible.

The tightness of the air-conditioning system is a very critical feature. Depending on the used refrigerant, a very harmful greenhouse gas can be released due to the escape of the refrigerant into the environment, for example, or the functioning or the functional safety of the air-conditioning system such as an air-conditioner in a motor vehicle can be compromised due to the escape of the refrigerant out of the air-conditioning system.

In practice, different air-conditioning systems in vehicles are employed, which have, depending on the number and type of the employed components, such as refrigerant compressors, condensers, evaporators, dryers, chillers and further heat exchangers, different valves and sensors, a differing number of connection points. In such air-conditioning systems, between 10 and 20 such connection points can be required, for example, in order to guarantee proper functioning of such air-conditioning systems.

Thus, there is a need for an improved air-conditioning system for a vehicle.

### SUMMARY

The object of the invention is to indicate an air-conditioning system for a vehicle with which a secure functioning, an improvement of the tightness, a reduction of the installation effort and the costs during production of an air-conditioning system are achieved.

The object is achieved by a subject matter with the features as shown and described herein.

It is provided that a multi-valve block is used in which several of the valves required in the air-conditioning system are arranged. Such valves are needle valves or ball valves, for example. Generally, all valves usually used in air-conditioning systems and in particular in refrigerant circuits, such as switch valves, expansion valves, 3/2-way valves both in an embodiment as needle valves and in an embodiment as ball valves can be employed. Furthermore, non-return valves can be employed in the multi-valve block as well.

Apart from the valves, other structural parts required in the air-conditioning system such as sensors can also be arranged in the multi-valve block according to the invention. Such sensors can be pressure sensors or temperature sensors, for example.

Such a multi-valve block can be embodied in the shape of a cube or in the shape of a cylinder, for example. A commitment to such shapes of the multi-valve block is not intended. The multi-valve block can be produced by means of an extrusion process, by means of a milling process, by means of a casting process or by means of a forging process, for example. The skilled person knows that the outer contours of the multi-valve block thus can be individually adjusted to different requirements, only provided that the required structural parts such as valves and sensors and the second internal connection lines arranged in the multi-valve block can be correspondingly arranged functionally in the multi-valve block. For simplification, the multi-valve block is hereinafter described and represented in the example of an embodiment which is nearly in the shape of a cube.

The multi-valve block has several attachment points on which attachment means are arranged which enable a connection to a connection line, such as for a refrigerant of the air-conditioning system. Thus, the connection of the multi-valve block to the other components of the air-conditioning system and in particular of the refrigerant circuit is via these attachment points.

The exemplary multi-valve block in the shape of a cube has second internal connection lines, in particular in the form of bores introduced into the multi-valve block, which form the internal connections between the valves, sensors arranged in the multi-valve block or other structural parts arranged in the multi-valve block.

These second internal connection lines between the structural parts such as valves or sensors arranged in the multi-valve block do not require any connection points such as coupling pieces or fittings known from the state of the art. Thus, the effort of sealing the connection lines is omitted and the possibility of an escape of the refrigerant or occurring pressure losses is eliminated. According to the invention, it is thus possible to save 40% to 70% of the connection points required in the state of the art.

For example, the second internal connection lines connect an attachment point of the multi-valve block with a valve or a sensor arranged in the multi-valve block. Furthermore, these second internal connection lines can, for example, also connect two or more valves arranged in the multi-valve block to one another.

It is furthermore provided that the second internal connection lines in the multi-valve block are arranged in several planes of the multi-valve block. Additionally, it is provided that the second internal connection lines in the multi-valve block are arranged running as straight as possible between the structural parts in the multi-valve block. Thus, the second internal connection lines in the multi-valve block only have small lengths which leads to a reduction of pressure losses through the connection lines required in a refrigerant circuit. Through the straight embodiment of the second internal connection lines, pressure losses are avoided as well, as occur in the state of the art through changes of direction of the flow movement of the refrigerant.

The arrangement of several structural parts such as valves and sensors in the multi-valve block reduces the number of possibly leaking connection points in the air-conditioning system. In an example embodiment of a first design of an air-conditioning system, in which, in a configuration according to the state of the art, thirteen connection points are required, the number of the connection points is reduced to only five connection points through the employment of a multi-valve block according to the invention, if at the same time the switch design is optimized to the use of the multi-valve block, as shown hereinafter in an example embodiment.

The multi-valve block can, for example, be produced from a metal such as aluminum, in which the second internal connection lines are introduced into, for example, several planes and in different directions through several bores or milled slots. Additionally, openings or bores such as counter bores are introduced into the multi-valve block, into which the valves to be arranged in the multi-valve block are introduced. Therefore, these openings for valves or counter bores for the valves are preferably arranged in an angle of 90 degrees to the second internal connection lines.

Through the central arrangement of several structural parts in the multi-valve block, a reduction of the installation space for the components of the air-conditioning system is achieved.

It is also provided to directly arrange the multi-valve block according to the invention with its construction elements on a refrigerant compressor without an additional connection line or to directly connect the multi-valve block to the refrigerant compressor. For this, the multi-valve block can, for example, be fixed to the refrigerant compressor by means of several connection screws.

This direct connection of the multi-valve block to the refrigerant compressor such as an electrical refrigerant compressor leads to a system consisting of a refrigerant compressor and a multi-valve block whose mass or total mass is larger than the mass of the refrigerant compressor.

It is known that vibrations are created when an electrical refrigerant compressor is operated. Such vibrations, which can also be connected with a noise formation, are perceived as annoying by passengers of a vehicle. Audible or noticeable vibrations ins vehicles, which are, for example, in a frequency range between about 20 Hz and 100 Hz, are referred to as noise, vibration, harshness (NVH). An electrical refrigerant compressor represents a vibration source which creates such disturbing vibrations.

Increasing the mass of the system consisting of a refrigerant compressor and a multi-valve block leads to an improved damping of these undesired vibrations. Thus, the NVH behavior of the air-conditioning system is improved.

It is furthermore provided to divide the multi-valve block into different temperature regions. Such regions with different temperatures are arranged separate from one another in practice in order to prevent a heat flow between the regions with different temperatures. In order to prevent such undesired heat flow between regions with different temperatures in the multi-valve block, a gap with a specified gap length between these regions is arranged in the multi-valve block. Such regions with different temperatures are, for example, a first region with a higher temperature which is in the range between 90° C. and 130° C., for example, and a second region with a lower temperature which is in the range between −10° C. and 60° C., for example.

As the gap, which usually fills with air from the environment along its gap length, has a much smaller thermal conductivity or a smaller coefficient of thermal conductivity than the material of the multi-valve block, a heat flow between the regions with different temperatures, i.e. the first region with a higher temperature and the second region with a lower temperature, is greatly reduced.

It is also provided to execute the gap with different widths along the gap length in order to prevent the heat flow between the regions with different temperatures in a targeted manner.

It is also provided to execute the gap in a straight manner only along its gap length. Thus, the course of the gap can, for example be adapted to the course of second internal connection lines or the installation location of structural parts with their fixation means in the multi-valve block. Such a gap can, for example, be introduced into the multi-valve block by means of milling, laser-cutting or electrical discharge machining. Alternatively, the gap can already be created during the production or shaping of the multi-valve block by means of an extrusion process, molding process or forging process.

The gap has a gap length which is embodied such that a reliable separation or decoupling of the first region with a higher temperature from the second region with a lower temperature is achieved. On the other hand, the gap length must be limited such that the tightness or stability of the multi-valve block is not compromised.

The gap can also have any shape which is only adapted to the functioning of the multi-valve block or to the structural elements arranged in the multi-valve block.

Furthermore, it is provided that one or more second internal connection lines of the multi-valve block are embodied with a maximum possible volume for the refrigerant flowing in the second internal connection lines. This is achieved by coordinating the placement of the structural elements in the multi-valve block and the course of at least one second internal connection line to one another and, for example, the diameter of this second internal connection line is maximized.

This volume increase enables to dampen the operationally generated pressure waves in the refrigerant created in the electric refrigerant compressor. Thus, the multi-valve block also represents a pressure vibration damper for the air-conditioning system.

The advantages to be achieved with the invention are, in particular:
a reduction of the length of the connection lines in an air-conditioning system,
a reduction of deflections in the connection lines and a reduction of pressure losses in the air-conditioning system,
a compact construction of the multi-valve block,
a central arrangement of control and measurement instruments such as valves and sensors in the multi-valve block,
a reduction of thermal losses through a gap in the multi-valve block,
a mechanical vibration damping for the electrical refrigerant compressor, and
a hydraulic vibration damping in the refrigerant or refrigerant circuit.

### DESCRIPTION OF DRAWINGS

Further details, features and advantages of the invention result from the following description of example embodiments with reference to the accompanying drawings. The following is shown:

FIG. 1: a layout for an air-conditioning system according to the state of the art in a first embodiment,

FIG. 2: a modified layout for the air-conditioning system according to FIG. 1 when using the multi-valve block according to the invention,

FIG. 3: a further layout for an air-conditioning system according to the state of the art in a second embodiment,

FIG. 4: a modified layout for the air-conditioning system according to FIG. 2 when using the multi-valve block according to the invention,

FIG. 5: a sub-assembly of an air-conditioning system with the multi-valve block according to the invention in a perspective representation,

FIG. 6: the sub-assembly of the air-conditioning system of FIG. 5 with the multi-valve block according to the invention in an explosive representation,

FIG. 7: the multi-valve block according to the invention obliquely from above in a perspective representation,

FIG. 8: the multi-valve block according to the invention obliquely from below in a perspective representation,

FIG. 9: a multi-valve block according to the invention and an electrical refrigerant compressor,

FIG. 10: an arrangement of two valves in the multi-valve block in a first variant,

FIG. 11: an arrangement of two valves in the multi-valve block in a second variant,

FIG. 12: a first variant of a thermal decoupling of regions in the multi-valve block through an arrangement of a gap, and

FIG. 13: a second variant of a thermal decoupling of regions in the multi-valve block through an arrangement of a gap.

### DESCRIPTION OF AN EMBODIMENT

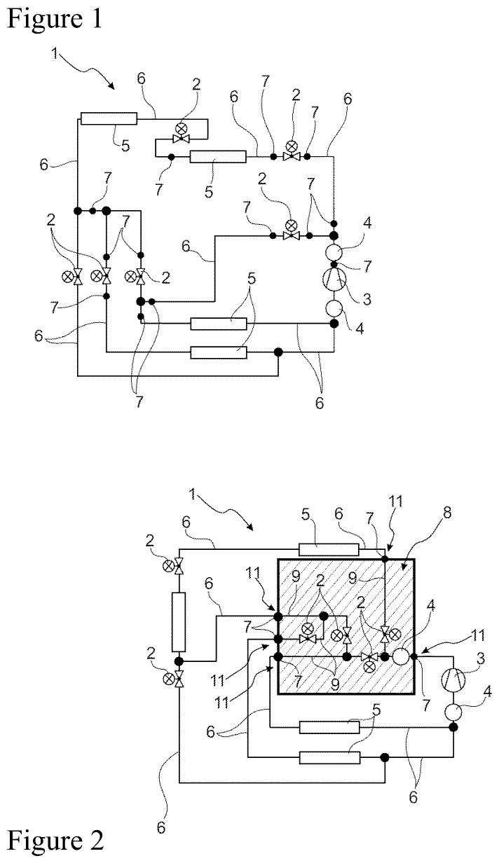

FIG. 1 shows a layout for an air-conditioning system 1 according to the state of the art in a first embodiment.

The air-conditioning system 1 comprises, for example, six first valves 2 which are embodied as two-way valves, an electrical refrigerant compressor 3, two sensors 4 which are embodied as pressure and/or temperature sensors, and four heat exchangers 5, which are operated as condensers, evaporators or chillers, for example. These structural parts of the air-conditioning system 1 are operatively connected to corresponding first connection lines 6, here also referred to as first external connection lines 6, wherein in the example of FIG. 1, thirteen connection points 7 are created, which represent sealing points of the refrigerant circuit of the air-conditioning system 1 to the environment. As already described, each one of these connection points 7 has a certain degree of leakage, which enables the refrigerant to escape from the refrigerant circuit of the air-conditioning system 1.

FIG. 2 shows a modified layout for the air-conditioning system 1 according to FIG. 1 when using the multi-valve block 8 according to the invention in the shape of a cube.

As can be recognized, the layout for the air-conditioning system 1 was optimized for the use of the multi-valve block 8 in the shape of a cube, wherein the functioning of the air-conditioning system 1 remains. By means of such optimization it is achieved that as many structural elements of the air-conditioning system 1 as possible are arranged in the multi-valve block 8. The connections between the structural elements arranged in the multi-valve block 8 such as first valves 2 and attachment points 11 or first valves 2 and sensors 4 and others, which are required for functionality, are executed as second internal connection lines 9 in the multi-valve block 8.

As can be recognized in FIG. 2, only five connection points 7 are required in the air-conditioning system 1 after optimization of the layout according to FIG. 1 and the employment of the multi-valve block 8 according to the invention.

These five connection points 7, which are all placed on the multi-valve block 8, correspond to the attachment points 11 of the multi-valve block 8, which are, for examples, positioned on the ends of the second internal connection lines 9. In order to connect the attachment points 11 of the multi-valve block 8 to corresponding first external connection lines 6 of the air-conditioning system 1, corresponding attachment means 12, which are not represented in FIG. 2, are arranged on the attachment points 11.

The multi-valve block 8 has several second internal connection lines 9 which are, for example, arranged between the attachment points 11 and a first valve 2 or a second valve or a sensor 4 or as connections between these structural parts. These second internal connection lines 9 are embodied in a straight line in the multi-valve block 8 in order to avoid changes of direction of the flow movement of the refrigerant and pressure losses connected therewith.

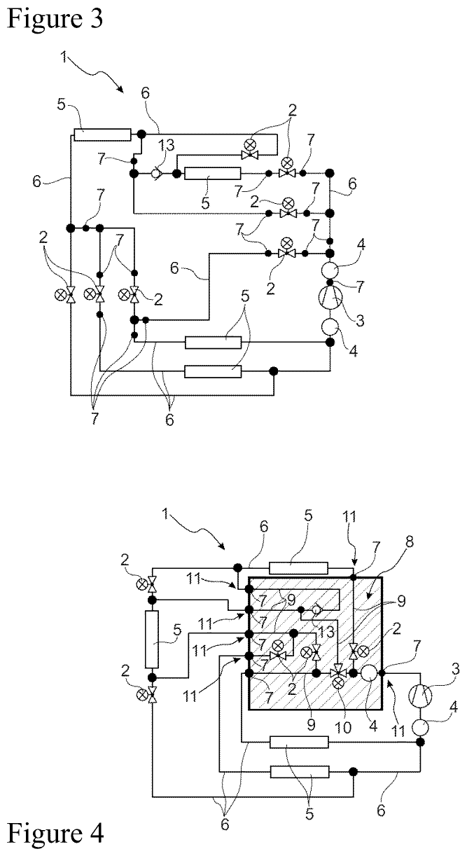

FIG. 3 shows a further layout for an air-conditioning system 1 according to the state of the art in a second embodiment.

The air-conditioning system 1 in FIG. 3 comprises, for example, seven first valves 2 which are embodied as two-way valves, an electrical refrigerant compressor 3, two sensors 4 which are embodied as pressure and/or temperature sensors, and four heat exchangers 5, which are integrated into the refrigerant circuit as condensers, evaporators or chillers, for example. In this layout of FIG. 3, a non-return valve 13 is arranged in the air-conditioning system 1 as well. These structural parts of the air-conditioning system 1 are operatively connected to one another with corresponding first external connection lines 6, wherein in the example of FIG. 3, fifteen connection points 7 are created, which represent sealing points of the refrigerant circuit of the air-conditioning system 1 to the environment. As already described, each one of these connection points 7 has a certain degree of leakage, which enables the refrigerant to escape from the refrigerant circuit of the air-conditioning system 1.

FIG. 4 shows a modified layout for the air-conditioning system 1 according to FIG. 3 when using the multi-valve block 8 according to the invention.

As can be recognized, the layout for the air-conditioning system 1 was optimized for the use of the multi-valve block 8, wherein the functionality of the air-conditioning system 1 remains. By means of such optimization, it is achieved that as many structural elements of the air-conditioning system 1 as possible are arranged in the multi-valve block 8. The connections between the structural elements arranged in the multi-valve block 8 such as first valves 2 or second valves 10 and the associated attachment points 11 or first valves 2 or second valves 10 and a sensor 4 and others, which are required for functionality, are executed as second internal connection lines 9 in the multi-valve block 8.

A further optimization is through the use of a second valve 10 which is embodied as a three-way valve. In the solution according to the invention, the non-return valve 13 of FIG. 3 is also arranged in the multi-valve block 8 in FIG. 4.

As can be recognized in FIG. 4, now only seven connection points 7 are required in the air-conditioning system 1 after optimization of the layout according to FIG. 3 and the employment of the multi-valve block 8 according to the invention.

These seven connection points 7, which are all placed on the multi-valve block 8, correspond to the attachment points 11 of the multi-valve block 8, which are positioned on the ends of the second internal connection lines 9, for example. In order to connect the attachment points 11 of the multi-valve block 8 to corresponding first external connection lines 6 of the air-conditioning system 1, corresponding attachment means 12, which are not represented in FIG. 4, are arranged on the attachment points 11.

In this embodiment as well, the multi-valve block 8 has several second internal connection lines 9 which are, for example, arranged between an attachment point 11 and a first valve 2 or an attachment point 11 and a second valve 10 or an attachment point 11 and a sensor 4 as connections between these structural parts. These second internal connection lines 9 are embodied as a straight line in the multi-valve block 8 in order to avoid changes of direction of the flow movement of the refrigerant in the second internal connection lines 9 and pressure losses connected therewith.

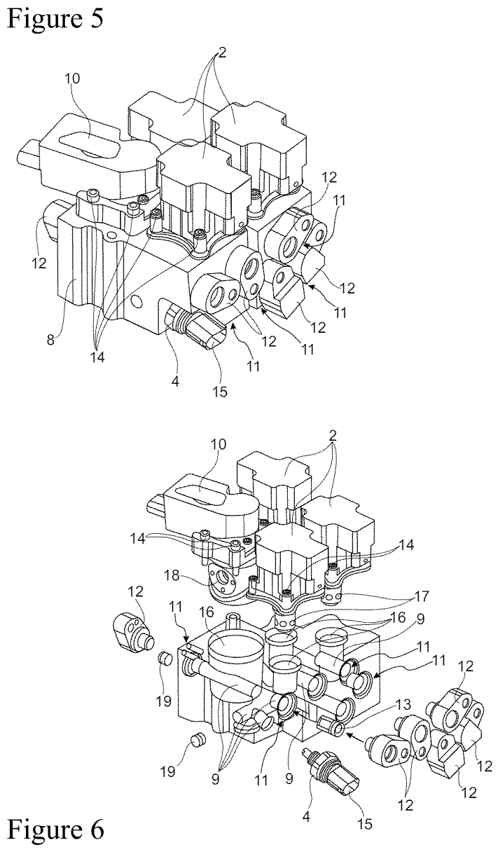

FIG. 5 shows a part of an air-conditioning system 1 with the multi-valve block 8 according to the invention.

FIG. 5 shows the multi-valve block 8 into which several valves have been introduced and fixed in prepared openings such as counter bores or correspondingly milled openings from the surface shown in FIG. 5. The valves can be first valves 2 or second valves 10, for example, which can be embodied as needle or ball valves. The valves 2 and 10 are fixed to the multi-valve block 8 by means of corresponding fixation means 14, such as screws. Valves 2 and 10 are arranged with corresponding sealing means, which are not represented in FIG. 5, and thus seal the respective prepared opening in the multi-valve block 8 so that no refrigerant can escape from the multi-valve block 8 or the refrigerant circuit of the air-conditioning system 1.

Furthermore, FIG. 5 represents the attachment means 12 arranged on the attachment points 11 of the multi-valve block 8. These attachment means 12 are arranged on the ends of the second internal connection lines 9 represented in FIG. 6 and enable the attachment of, for example, first external connection lines 6 in order to create the connections in the air-conditioning system 1 which are required for functionality. For this, the attachment means 12 are equipped correspondingly and enable a tight connection to the first external connection lines 6.

Depending on the requirement, these attachment means 12 can have an attachment for a first external connection line 6, represented in FIGS. 2, 3 and 4, for example, wherein the attachment lies in an extension of an imaginary longitudinal axis of a second internal connection line 9. Alternatively, an attachment for a first external connection line 6 can be in an angle of 90 degrees to the longitudinal axis of the second internal connection line 9, for example. Thus, differently embodied attachment means 12 are represented in FIG. 5.

The first external connection lines 6 and the second internal connection lines 9 are not represented in FIG. 5.

FIG. 5 also shows a sensor 4 arranged in an attachment point 11 of the multi-valve block 8, which is embodied as a pressure and/or temperature sensor and can thus detect the pressure and/or the temperature of the refrigerant in the multi-valve block 8 on the represented point in the second internal connection lines 9. The sensor 4 has a corresponding attachment 15 for a connection to an electrical attachment line.

FIG. 6 shows the sub-assembly of the air-conditioning system 1 of FIG. 5 with the multi-valve block 8 according to the invention in an explosive representation.

FIG. 6 additionally shows the multi-valve block 8 in a way in which the openings 16 for the valves 2, 10 or counter bores for the valves 2, 10 introduced into the multi-valve block 8 and the second internal connection lines 9 in the multi-valve block 8 can be recognized.

The needle valve inserts 17 of the first valves 2 and the ball valve insert 18 of the second valve 10 can be recognized as well.

The represented attachment means 12 can be equipped with an adjustment means such as a pin and openings for the introduction of a fixation means such as a screw. With the adjustment means, the attachment means 12 can be positioned on the corresponding attachment point 11 in a quick and secure manner. The fixation means 14 provides for a fixed and tight placement of the attachment means 12 on the corresponding attachment point 11.

In FIG. 6, a non-return valve 13 is furthermore represented, which is inserted into the second internal connection line 9 in the multi-valve block 8 in the direction represented with the associated arrow before the associated attachment means 12 is arranged and fixed on the associated attachment point 11 in the direction also represented by means of an arrow.

In the representation of FIG. 6, two closure means 19 are represented as well, which have the task of closing production-related openings.

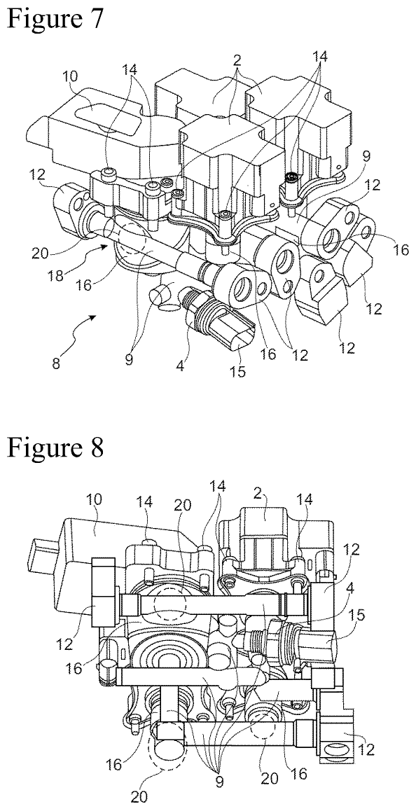

FIG. 7 also shows the part of the air-conditioning system 1 according to FIG. 5, wherein in this representation, the multi-valve block 8 according to the invention is represented as transparent for a better understanding of the invention. FIG. 7 shows the part of the air-conditioning system 1 obliquely from above in a perspective representation.

The represented structural parts of the air-conditioning system 1 were already described in detail in FIGS. 5 and 6, therefore a new description is omitted here in order to avoid repetitions.

In FIG. 7, the openings for valves arranged in the interior of the multi-valve block 8, such as counter bores or milled openings 16 for the valves 2, 10, are represented. Additionally, the second inner connection lines 9 can be recognized well, which have a mostly straight course and thus do not offer any notable flow resistance to the refrigerant flowing in the second inner connection lines 9.

In the region of the non-represented ball valve insert 18 of the second valve 10, a connection region 20 between the opening 16 and an associated second inner connection line 9 can be recognized. This connection region 20 was marked with a dash-dash line. Via such connection region 20, a refrigerant from the region of the opening 16, for example, can flow into the region of a second internal connection line 9 or vice versa.

The openings 16 for the valves 2, 10 are arranged in an angle of 90 degrees to the second internal connection lines 9.

FIG. 8 also shows the part of the air-conditioning system 1 according to FIG. 5, wherein in this representation the multi-valve block 8 according to the invention is also represented transparent for a better understanding of the invention. FIG. 8 shows the part of the air-conditioning system 1 obliquely from below in a perspective representation.

The represented structural parts of the air-conditioning system 1 were already described in detail in FIGS. 5 and 6, therefore a new description is omitted here in order to avoid repetitions.

In FIG. 8 as well, the openings for valves arranged in the interior of the multi-valve block 8, such as counter bores or milled openings 16 for the valves 2, 10, are represented. Additionally, the second inner connection lines 9 can be recognized well, which have a mostly straight course and thus do not offer any notable flow resistance to the refrigerant flowing in the second inner connection lines 9.

In FIG. 8 as well, the connection region 20 between the opening 16 for the second valve 10 and an associated second inner connection line 9 are marked. Additionally, two further connection regions 20 respectively between an opening 16 for a first valve 2 and an associated second internal connection line 9 are represented.

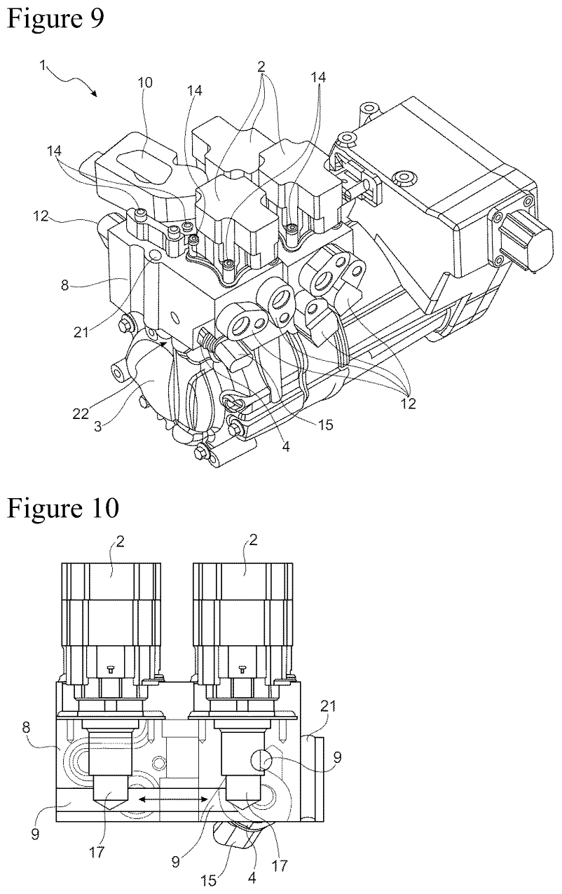

FIG. 9 shows a part of the air-conditioning system 1 with the multi-valve block 8 according to the invention and an electrical refrigerant compressor 3.

Again, the structural parts in or on the multi-valve block 8 correspond to the indications of FIG. 5 to FIG. 8. Apart from the multi-valve block 8, three first valves 2, a sensor 4 with its attachment 15, a second valve 10, six attachment means 12 and several fixation means 14 are represented.

In FIG. 9, the multi-valve block 8 according to the invention is arranged on an electrical refrigerant compressor 3, wherein the multi-valve block 8 has several bores 21 for connection screws. The multi-valve block 8 is tightly screwed with the refrigerant compressor 3 with non-represented connection screws which are arranged in the bores 21. In FIG. 9, only one bore 21 for a connection screw is represented as an example.

The multi-valve block 8 is arranged on the electrical refrigerant compressor 3 so that a tight refrigerant transition point 22 is created. This refrigerant transition point 22 is formed by an outlet of the electrical refrigerant compressor 3 for a refrigerant and an attachment point 11 of the multi-valve block 8 which forms the inlet for the refrigerant in the multi-valve block 8. Thus, the refrigerant compressed by the electric refrigerant compressor 3 can flow into a second internal connection line 9 of the multi-valve block 8 on the inlet side via the outlet of the electric refrigerant compressor 3 for the refrigerant and via the corresponding attachment point 11 of the multi-valve block 8. This refrigerant transition point 22 is marked in FIG. 9 by means of an arrow as it cannot be shown directly due to the kind of representation of FIG. 9.

The tight connection of the multi-valve block 8 to the electrical refrigerant compressor 3 creates a system consisting of a refrigerant compressor 3 and a multi-valve block 8 and which has a higher mass than the refrigerant compressor 3 alone. This mass increase leads to a better damping of undesired vibrations (NVH) which are created during the operation of the electrical refrigerant compressor 3.

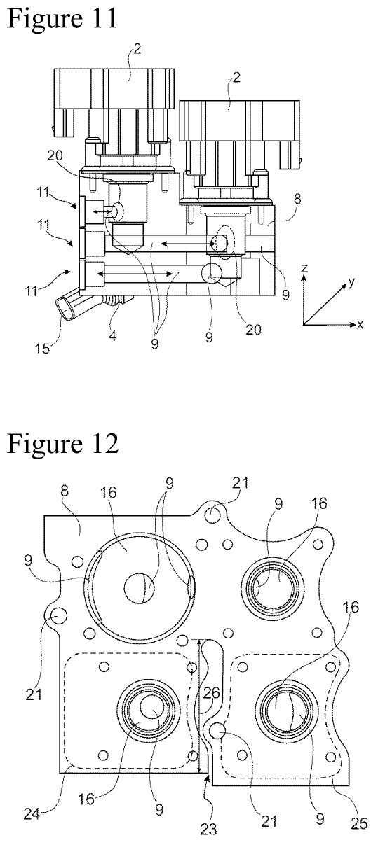

FIG. 10 shows an arrangement of two valves 2, 10 in the multi-valve block 8 in a first variant.

FIG. 10 shows two valves, which can be first valves 2 and/or second valves 10, in an exemplary embodiment with two first valves 2. In FIG. 10, the valves 2 are arranged one next to another in the same plane. In the representation of FIG. 10, the multi-valve block 8 is represented semi-transparent. Thus, the needle valve inserts 17 of the valves 2 can be recognized in the interior of the multi-valve block 8. The second internal connection lines 9 in the multi-valve block 8 can also be partially recognized.

It can also be recognized that the second internal connection lines 9 in the multi-valve block 8 are embodied as a straight line in order to minimize flow losses. This straight design is represented by means of a double arrow in FIG. 10.

FIG. 10 also shows a sensor 4 arranged in the multi-valve block 8 with its attachment 15 and a bore 21 for a connection screw in which a non-represented connection screw is arranged in order to create a tight connection between the multi-valve block 8 and the refrigerant compressor 3.

FIG. 11 shows an arrangement of two valves 2, 10 in the multi-valve block 8 in a second variant.

FIG. 11 also shows two valves, which can be first valves 2 and/or second valves 10, in an exemplary embodiment with two first valves 2. In FIG. 11, the valves 2 are arranged one next to the other in different planes. In an example X-Y-Z-coordinate system (X-axis for width, Y-axis for length, Z-axis for height), several planes on and in the multi-valve block 8 are provided along the Z-coordinate.

Valves 2 or 10 can be arranged in the different planes on the multi-valve block 8. The second internal connection lines 9 in the multi-valve block 8 can be arranged in the different planes in the interior of the multi-valve block 8. In the example of FIG. 11, two planes are represented on the multi-valve block 8, i.e. on the surface of the multi-valve block 8. Furthermore, three planes in the multi-valve block 8 are represented in which the second internal connection lines 9 are arranged.

The multi-valve block 8 is also represented semi-transparent in the representation of FIG. 10 and FIG. 11. Thus, the needle valve inserts 17 of the valves 2 can be recognized in the interior of the multi-valve block 8. Two connection regions 20, in which a refrigerant from a second internal connection line 9, for example, can flow into a non-represented opening 16 for the valve 2, in which the needle valve insert 17 is arrange, or vice versa, can also be recognized as an example.

It can also be recognized that the second internal connection lines 9 in the multi-valve block 8 are embodied as a straight line in all planes in order to minimize flow losses. The straight design is represented by means of a double arrow per plane in FIG. 11.

Furthermore, FIG. 11 shows three transitions of the second internal connection lines 9 to the attachment points 11 of the multi-valve block 8 and, at least partially, a sensor 4 with its attachment 15.

FIG. 12 shows a first variant of a thermal decoupling of two regions 24 and 25 with different temperatures in the multi-valve block 8 through an arrangement of a gap 23.

The multi-valve block 8 in FIG. 12 is shown in a view from above in the direction of the Z-coordinate in FIG. 11. This multi-valve block 8 in FIG. 12 is produced by means of an extrusion method, for example. Three bores 21 for connection screws which are not represented in FIG. 12 can be recognized. By means of these connection screws, a fixed connection between the multi-valve block 8 and the non-represented refrigerant compressor 3 is created.

The multi-valve block 8 has four openings 16 for valves 2, 10 which extend into the depth of the multi-valve block 8 in the representation of FIG. 12. Three openings 16 of about the same size are, for example, prepared for one respective non-represented needle valve insert 17 and respectively receive one first valve 2. Larger openings 16 in the multi-valve block 8 are prepared for the non-represented ball valve insert 18 of a second valve 10.

In the openings 16 for the valves 2, 10, tabs or ends of the second internal connection lines 9 introduced into the multi-valve block 8 can be recognized.

For functional reasons, the multi-valve block 8 in the example of FIG. 12 should have a first region 24 with a higher temperature and a second region 25 with a temperature which is lower compared to the first region 24. In order to prevent an undesired heat flow between regions 24 and 25 with different temperatures, a gap 23 is arranged between these regions 24 and 25 in the multi-valve block 8. In FIG. 12, these regions 24 and 25 are represented outlined by means of a dash-dash line.

The gap 23 in FIG. 12 has different widths along the depth of the gap 23 which is referred to as gap length 26. The gap length 26 of the gap 23 is measured such that the heat decoupling of the regions 24 and 25 is enabled, but the tightness of the multi-valve block 8 is not restricted too much.

As can be recognized in FIG. 12, the course and the width of the gap 23 was adapted to structural circumstances such as a bore 21 for a connection screw or non-represented fixation means 14 for the valves 2, 10, the bores of which can be recognized in the multi-valve block 8.

As the gap 23 fills with the environmental air along its gap length 26 and this air has a significantly lower coefficient of thermal conductivity compared to the material of the multi-valve block 8, a heat flow between the regions 24 and 25 or vice versa as well is significantly reduced.

The outer contours of the multi-valve block 8 as well can be adapted to structural circumstances such as a bore 21 for a connection screw or non-represented fixation means 14 for the valves 2, 10, the bores of which can be recognized in the multi-valve block 8. Thus, material and weight savings can be achieved, for example. Additionally, the outer contours of the multi-valve block 8 can also be structurally adapted to adjacent assemblies, lines or aggregates.

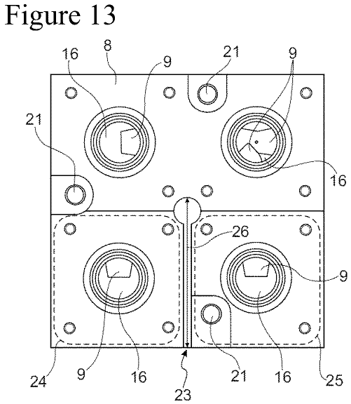

FIG. 13 shows a second variant of a thermal decoupling of two regions 24 and 25 with different temperatures in the multi-valve block 8 through an arrangement of a gap 23.

The multi-valve block 8 in FIG. 13 is shown in a view from above in the direction of the Z-coordinate in FIG. 11. Three bores 21 for connection screws which are not represented in FIG. 13 can be recognized. By means of these connection screws, a fixed connection between the multi-valve block 8 and the non-represented refrigerant compressor 3 is created.

The multi-valve block 8 has four openings 16 for valves 2 which extend into the depth of the multi-valve block 8 in the representation of FIG. 13. These four openings 16 are, for example, prepared for one respective non-represented needle valve insert 17 and respectively receive one first valve 2.

In the openings 16 for the valves 2, tabs or ends of the second internal connection lines 9 introduced into the multi-valve block 8 can be recognized.

For functional reasons, the multi-valve block 8 should have a first region 24 with a higher temperature and a second region 25 with a lower temperature compared to the first region 24 in the example of FIG. 13 as well. In order to prevent an undesired heat flow between regions 24 and 25 with different temperatures, a gap 23 is arranged between these regions in the multi-valve block 8. Again, the regions 24 and 25 in FIG. 13 are represented surrounded by means of a dash-dash line.

The gap 23 in FIG. 13 has a width which remains constant along the length of the gap 23, which is referred to as gap length 26. The gap length 26 of the gap 23 is measured such that the heat decoupling of the regions 24 and 25 is enabled, but the tightness of the multi-valve block 8 is not restricted too much. In this embodiment, the gap 23 is designed in a simple manner which leads to the fact that the gap 23 is simpler to produce or can be introduced into the multi-valve block 8 in a simpler manner.

As the gap 23 fills with the environmental air along its gap length 26 and this air has a significantly lower coefficient of thermal conductivity compared to the material of the multi-valve block 8, a heat flow between the regions 24 and 25 or vice versa is significantly reduced.

The outer contours of the multi-valve block 8 as well are designed in a simpler manner compared to FIG. 12 and decrease the effort during the production of the multi-valve block 8 compared to the production of a multi-valve block 8 according to FIG. 12.

### List of Reference Numerals

1 air-conditioning system
2 first valve
3 electrical refrigerant compressor
4 sensor
5 heat exchanger (evaporator/condenser)
6 first external connection lines
7 connection points
8 multi-valve block
9 second internal connection lines
10 second valve
11 attachment point
12 attachment means
13 non-return valve
14 fixation means
15 attachment
16 openings for valves
17 needle valve insert
18 ball valve insert
19 closure means
20 connection region
21 bore for connection screws
22 refrigerant transition point
23 gap
24 first region with higher temperature
25 second region with lower temperature
26 gap length

1-11. (canceled)

12. An air-conditioning system for a vehicle comprises:
valves;
a refrigerant compressor;
sensors; and
heat exchangers, wherein first external connection lines are arranged between each of the valves, the refrigerant compressor, the sensors, and the heat exchangers, wherein a multi-valve block is arranged in the air-conditioning system in which the valves and at least one of the sensors are arranged, in that the multi-valve block has several attachment points and in that second internal connection lines are arranged between the attachment points and structural parts of the multi-valve block.

13. The air-conditioning system according to claim 12, wherein the multi-valve block is embodied in a shape of a cube or in a shape of a cylinder.

14. The air-conditioning system according to claim 12, wherein a first type of the valves arranged in the multi-valve block is a needle valve, or a second type of the valves is a ball valve.

15. The air-conditioning system according to claim 12, wherein a non-return valve is arranged in the multi-valve block.

16. The air-conditioning system according to claim 12, wherein a first one of the sensors is a temperature sensor or a pressure sensor.

17. The air-conditioning system according to claim 12, wherein attachment means which are connected to the first external connection lines are arranged on the attachment points of the multi-valve block.

18. The air-conditioning system according to claim 12, wherein a gap is arranged in the multi-valve block between a first region with a higher temperature and a second region with a lower temperature.

19. The air-conditioning system according to claim 18, wherein the gap has different widths along its gap length and/or in that the gap runs deviating from a linear course in consideration of a placement of the structural parts in the multi-valve block.

20. The air-conditioning system according to claim 12, wherein the valves include three first valves, one second valve, and a non-return valve, as well as a first one of the sensors with corresponding ones of the second internal connection lines are arranged in the multi-valve block.

21. The air-conditioning system according to claim 12, wherein the multi-valve block is arranged on the refrigerant compressor with fixation means.

22. The air-conditioning system according to claim 12, wherein the valves are arranged in openings and in that the openings have a connection region with a connection to one of the second internal connection lines.
